(19) United States
(12) Patent Application Publication
(10) Pub. No.: US 2016/0159431 A1
(43) Pub. Date: Jun. 9, 2016

(54) ELECTRIC CYCLE HAVING PEDAL FORCE-BASED PROPULSION SYSTEM

(71) Applicant: GM Global Technology Operations LLC, Detroit, MI (US)

(72) Inventors: Steven L. Hayslett, TROY, MI (US); GORO TAMAI, BLOOMFIELD HILLS, MI (US); SHAWN H. SWALES, CANTON, MI (US)

(21) Appl. No.: 14/562,143

(22) Filed: Dec. 5, 2014

(51) Int. Cl. B62M 6/50; B62M 6/55; B62M 6/70

(52) U.S. Cl. CPC B62M 6/50; B62M 6/70; B62M 6/55; B62K 2204/00

(57) ABSTRACT

A number of variations may include an electric cycle having a pedal force-based propulsion system, which allows the rider to provide intuitive input commands using foot pedals.

### TECHNICAL FIELD

The field to which the disclosure generally relates to includes electric cycles having pedal force-based propulsion systems.

### SUMMARY OF ILLUSTRATIVE VARIATIONS

A number of variations may include an electric cycle having a pedal force-based propulsion system, which allows the rider to provide intuitive input commands using foot pedals.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a side view of an electric cycle according to a number of variations.

FIG. 2A is a schematic illustration of a section of a mechanism for use in a pedal force-based propulsion system wherein the mechanism includes a plurality of tabs in a retracted position and constructed and arranged to allow free movement of the cycle pedal crank in a forward and reverse direction according to a number of variations.

FIG. 2B is a schematic illustration of a section of a mechanism as shown in FIG. 2A but with a plurality of tabs in the up position to lock the mechanism preventing rotational movement of the electric cycle crank according to a number of variations.

FIG. 2C is a schematic illustration of a section of a mechanism as shown in FIG. 2A but with one of the tabs in an up position and the other tab in a down position to allow only counterclockwise rotation of the crank mechanism of the electric cycle according to a number of variations.

FIG. 2D is a schematic illustration of a section of a mechanism as shown in FIG. 2A but with one of the tabs in the up position and the other tab in the down position to allow only clockwise rotation of the electric cycle according to a number of variations.

FIG. 3 is a schematic illustration of a general arrangement for an electric cycle according to a number of variations.

FIG. 4 is a schematic illustration of a mode of operation of an electric cycle wherein the mechanical mechanism is constructed and arranged so that the crank pedals are disconnected from the electric power train and so that a rider may input power to the chain ring but may not receive power from either the electric motor/generator or wheel according to a number of variations.

FIG. 5 is a schematic illustration of a first state of operation of a pedal force based propulsion system for an electric cycle according to a number of variations.

FIG. 6 is a schematic illustration of a second state of operation of a pedal force based propulsion system for an electric cycle according to a number of variations.

FIG. 7 is a schematic illustration of a third state of operation of a pedal force based propulsion system for an electric cycle according to a number of variations.

FIG. 8 is a chart of three different states, modes of operation, E1 status, and E2 status, according to a number of variations.

### DETAILED DESCRIPTION OF ILLUSTRATIVE VARIATIONS

The following description of the variations is merely illustrative in nature and is in no way intended to limit the scope of the invention, its application, or uses.

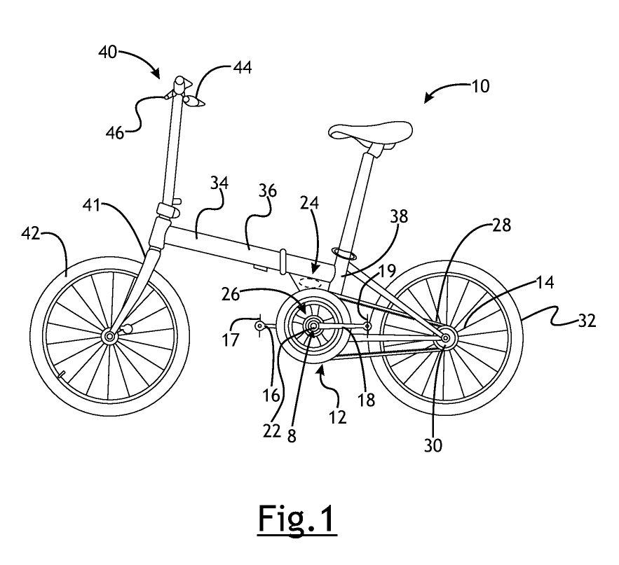

FIG. 1 illustrates a number of variations which may include an electric cycle 10. The electric cycle 10 may have a pedal force-based propulsion system, which allows the rider to provide intuitive input commands using foot pedals. The input commands are intuitive to the rider and are similar to riding a non-motorize bicycle wherein the rider applies a clockwise force to a bicycle crank by applying force to a forward positioned foot pedal to move the bicycle in a forward direction, and the rider applies a counter clockwise force to the bicycle crank by applying force to a rearward positioned foot pedal to slow the bicycle.

Reference herein as to clockwise or counter-clockwise is made with respect to the right hand side of the cycle with an operator facing the forward direction of movement of the electric cycle.

The electric cycle 10 may include a mechanical mechanism 26 that may be selectively constructed and arranged to provide for at least one of: (1) the free rotation of the first and second pedal assemblies in both the clockwise and counterclockwise directions; (2) locking the first and second pedal assemblies and preventing rotation in both the clockwise and counterclockwise directions; (3) locking the first and second pedal assemblies preventing movement in the clockwise direction and allowing rotation in the counterclockwise direction; or (4) locking the first and second pedal assemblies preventing rotation in the counterclockwise direction but allowing rotation in the clockwise direction. The electric cycle 10 may include a means for measuring the torque applied to pedal assemblies to control operations of at least one of an electric motor/generator or a regenerative braking system.

The electric cycle 10 that may be selectively constructed and arranged to provide for at least one of the following state functions: (A) Assist function wherein the torque (and optionally the speed and direction of the crank) is detected and assistance in rotating the crank is provided by the electric motor/generator in response to the detected torque, (and optionally the speed and direction of the crank); (B) Coast with spinning motor/generator function wherein the crank is coupled to the electric motor/generator and the ride is not rotating the pedals of the electric cycle; (C) Electronic coaster with regenerative braking; (D) Pedal force throttle function wherein the clockwise rotation of the crank is locked and wherein the force applied on a forward pedal by the rider is detected and used as a throttle input to the motor/generator; (E) Coast with rear hub function; or (F) Pedal mode without back drive lockup wherein the rider can rotate the crank in a clockwise direction to move the electric cycle forward, and the ride can rotate the crank in a counter clockwise direction in a free spinning mode without back drive lockup or locking the rear wheel when moving backwards.

The electric cycle 10 may be a bicycle, tricycle, or four-wheel electric cycle having a crank assembly 8 constructed and arranged to allow a rider to provide input thereto using a first pedal assembly 16 and a second pedal assembly 18.

In any of a number of variations, an electric cycle 10 may include an electric motor/generator 12 which may be used to propel the electric cycle 10 forward and to generate electricity from motor braking. In any of a number of variations, the electric motor/generator 12 may be powered by any of a number of types of battery assemblies 14.

In any of a number of variations, a motor/generator 12 may be attached to the electric cycle 10 adjacent the pedal assemblies 16, 18, chain ring 20 (or belt ring) and/or crank 22. The placement of the motor/generator 12 in this area may provide additional packaging space in the motor/generator so that the motor/generator may be integrated with additional power train components including, but not limited to, one or more battery assembly 14, internal hub gears, override gears, a cycle roller-based continuously variable transmission (CVT) and/or control electronics 24 that may be provided. The motor/generator 12 may increase the structural integrity and efficiency of the electric cycle 10 and/or may reduce the weight of the electric cycle 10. The motor/generator 10 may include any of a number of types of motor/generators including, but not limited to, a permanent magnet AC machine, either surface mount or interior permanent magnet rotor. In any of a number of variations, a brushless in runner ring motor/generator may comprise a stator and rotor.

In any of a number of variations, the motor/generator 10 may be attached to the cycle frame 34 In one variation, the cycle frame 32 may include a top tube 36 connected to a seat tube 38. Handlebars 40 may be attached to the top tube 36 and the handlebars 40 may be operatively connected to a front wheel 42 by way of a wheel fork 41. Control levers 44 may be provided on the handlebars 40 and may be constructed and arranged to communicate with electronic controls 24, the mechanical mechanism 26 and/or the motor/generator 12. The electronic controls 24 may include electronic processing components to receive input signals and to send out signals to control variation components of the cycle, which may include sending output signals to control operation of the electric motor/generator 12. In a number of variations the electronic controls 12 may include memory, a processor and software and/or hardware to process input signals and generate output signals, and may include formulas, lookup table or other means for comparing and processing data. A brake lever 46 may be also provided on the handlebars 40, if desired. The crank mechanism 8 may include a crankshaft 22 having a first pedal assembly 16 and a second pedal assembly 18 connected thereto. The first pedal assembly 16 may include a first foot pedal 17, and the second pedal assembly 18 may include a second foot pedal 19. A mechanical mechanism 26 may be provided in the crank assembly 8 as will be described hereafter. A chain ring or sprocket 20 may be operatively connected to the crank 22 for driving a chain 28 operatively connected to a rear sprocket 30 of a rear wheel 32.

The mechanical mechanism 26 may be of any type suitable to provide at least one of the following: (1) allowing for the free rotation of the first and second pedal assemblies 16, 18 in both the clockwise and counterclockwise directions; (2) locking the first and second pedal assemblies 16, 18 and preventing rotation in both the clockwise and counterclockwise directions; (3) locking the first and second pedal assemblies 16, 18 preventing movement in the clockwise direction and allowing rotation in the counterclockwise direction; or (4) locking the first and second pedal assemblies 16, 18 preventing rotation in the counterclockwise direction but allowing rotation in the clockwise direction.

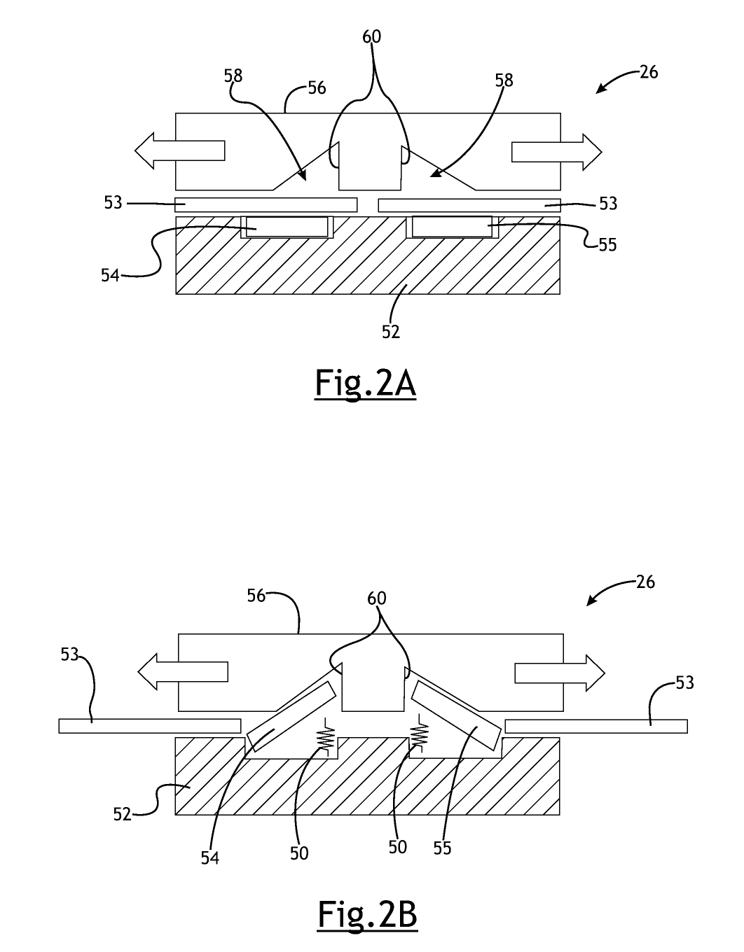

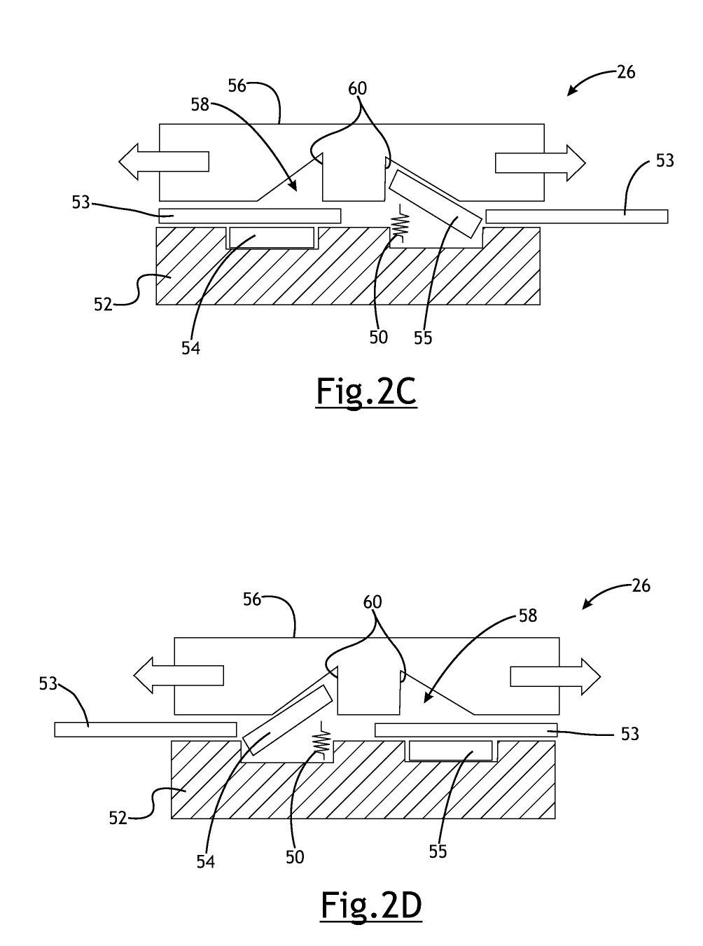

A number of variations are illustrated in FIG. 2A-2D wherein the mechanical mechanism 26 may include a base plate 52 having a plurality of tabs 54, 55 (first tabs 54 and second tab 55, or first set of tabs 54 and second set of tabs 55) pivotally connected thereto. A spring 50 may be provide for each tab 54, 55. The spring 50 may be connected to a tab 54, 55 and to the base plate 52 to bias the tab 54, 55 in one direction. A solenoid or servo may be provided having a shaft or piston 53 that may be selectively moved out of an overlying position with respect to one of the tabs 54, 55 so that the spring 50 biases that tab 54, 55 upward and the tab 54, 55 engages a should 60 of the cap 52. The mechanical mechanism 26 may include a cap 56 for lying over the base plate 52. The cap may be operatively connected to the crank 22. The cap 56 may have a plurality of recesses 58 formed therein defined by features in the cap 56 so that each of the plurality of recesses 58 is defined in part by a shoulder 60 against which the tabs 54, 55 may lock and prevent rotation of the cap 56 in one direction and/or the other direction. The cap 56 may be operatively tied to the crank 22 to allow or prevent rotation of the same. The mechanical mechanism 26 may, in a number of variations, be servo controlled, causing the tabs 54, 55 to move into or out of locking position with respect to the shoulder 60 of the recesses 58 formed in the cap 56.

FIG. 2A is a schematic illustration showing a mechanical mechanism 26 with the tabs 54, 55 in a retracted position with respect to the base plate 52 so that the cap 56, which is tied to the crank 22, is free to rotate in both the clockwise and counterclockwise directions.

FIG. 2B is a schematic illustration of a mechanical mechanism 26 wherein the first tab 54 (or first set of tabs 54) is in an elevated position so that they engage a shoulder 60 formed in the cap 56, which is tied to the crank 22, thereby preventing movement of the cap 56 and the crank 22 in both the clockwise and counterclockwise directions.

FIG. 2C is a schematic illustration of a mechanical mechanism 26 wherein the second tab 55 (or second set of tabs 55) is in an elevated position with respect to the base plate 52 and so that the tab 55 engages a shoulder 60 formed in the cap 56 preventing clockwise movement of the cap 56 and the crank 22. However, the first tab 54 (or first set of tabs 54) is in a retracted position with respect to the base plate 52 and does not engage a shoulder 60 and thereby allows counterclockwise movement of the cap 56 and the crank 22 tied thereto.

FIG. 2D is a schematic illustration of a mechanical mechanism 26 wherein the first tab 54 (or first set of tabs 54) is in an elevated position with respect to the base plate 52 and so that the first tab 54 engages a shoulder of the cap 56, preventing counterclockwise movement of the cap 56 and the crank 22 tied thereto. However, the second tab 55 (or second tab set) is in a retracted position with respect to the base plate 52 and does not engage a shoulder 60 of the cap, thereby allowing clockwise rotation of the cap 56 and of the crank 22 tied thereto.

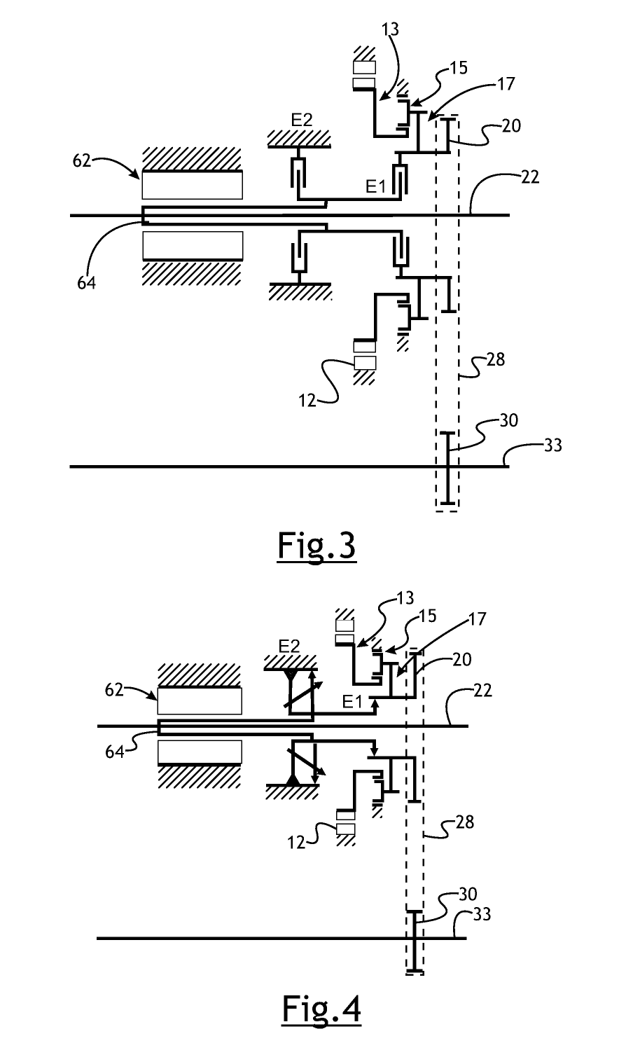

FIG. 3 is a schematic illustration of general arrangement for an electric cycle 10 according to a number of variations. In the arrangement illustrated by FIG. 3, the pedal assemblies 16, 18 are connected to the crank 22. In this arrangement, a clutch assembly E1 disconnects the pedal assemblies 16, 18 from the electric power train and electric motor/generator 12 but allows the rider to input power to the chain ring 20 but not receive power from either the motor/generator 12 or the wheel. A gear set may be provided wherein a planetary gear set 17 may be driven by motor 12, a planet carrier or gear 15 is tied to the chain ring 20 of the cycle, and ring gear 12 is grounded. Such a gear set results in an increase in torque between the input and output of the planetary gear set and also in reduction in speed. Rotation is in a common direct between input and output. A torque sensor 62 may be provided and may include, in one variation, a tube 64 operatively connected to the crank 22 so that the distortion of the tube 64 may be measured and is indicative of the torque, speed and direction of rotation of the crank 22. Other sensors may be included is desired, for example but not limited to, speed of crank sensor, position of crank sensor or direction of crank movement sensor. The rider may selective engage and disengage the clutch E2, for example, using a control lever 44 which may be located on the handlebars 40. E2 may be used to open and close each rotational direction. When the pedals are locked in both directions, inputs on the pedals are sensed by sensor 62 and the motor 12 may push the chain ring (sprocket) 20 overrunning E1. FIGS. 4-7 illustrate different operations of E2.

This mode of operation illustrated by FIG. 4 allows for the following state functions: (A) Assist function wherein the torque, speed and direction of the crank is detected and assistance in rotating the crank is provided by the electric motor/generator in response to the detected torque, speed and direction of the crank; (B) Coast with spinning motor/generator function wherein the crank is coupled to the electric motor/generator and the ride is not rotating the pedals of the electric cycle; (C) Electronic coaster with regenerative braking (or energy capture); (D) Pedal force throttle function wherein the clockwise rotation of the crank is lock and wherein the force applied on a forward pedal by the ride is detected and used as a throttle input to the motor/generator; and (F) Pedal mode without back drive lockup wherein the rider can rotate the crank in a clockwise direction to move the electric cycle forward, and the ride can rotate the crank in a counter clockwise direction in a free spinning mode without back drive lockup.

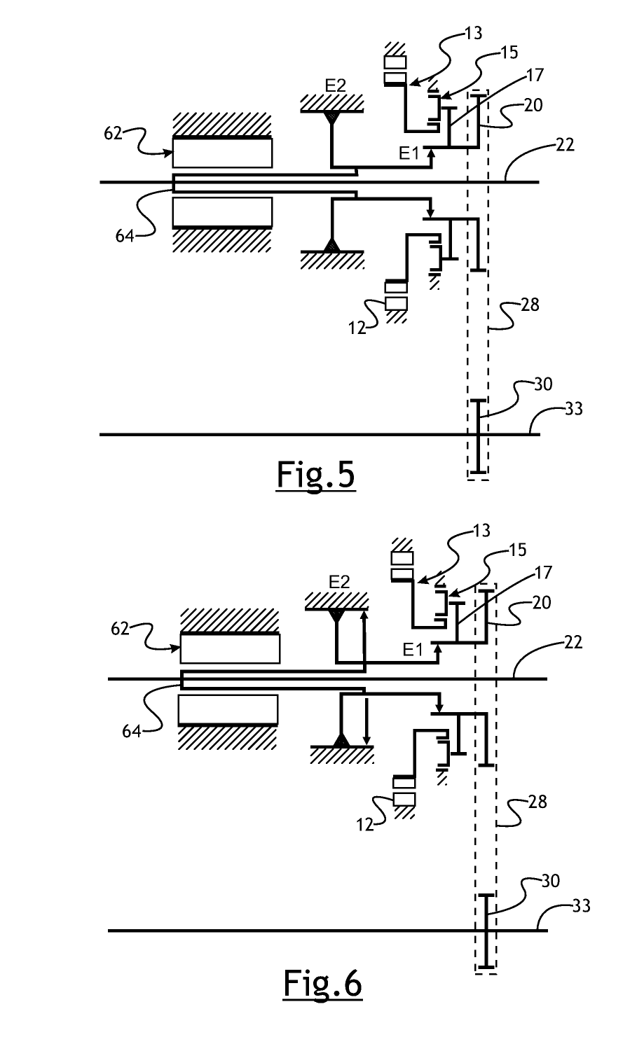

FIG. 5 illustrates another mode of operation of the electric cycle 10 according to a number of variations. In the mode of operation illustrated by FIG. 5, the pedal assemblies 16, 18 are locked in a horizontal position and the mechanical mechanism 26 prevents counter clockwise rotation of the crank 22 and allows for a regenerative braking command to be sent by a back-pedal force (counterclockwise) applied to one of the pedal assemblies 16, 18. The torque, speed, direction sensor 62 is used to modulate regenerative braking torque of the motor/generator 10 while the electric cycle is in a coaster brake mode. The torque, speed and direction sensor 62 is also used to modulate motoring torque of the motor/generator 10 while in a pedaling mode. This mode of operation illustrated in FIG. 5 allows for the following state functions: (A) Assist function wherein the torque, speed and direction of the crank is detected and assistance in rotating the crank is provided by the electric motor/generator in response to the detected torque, speed and direction of the crank; (B) Coast with spinning motor/generator function wherein the crank is coupled to the electric motor/generator as the ride is not rotating the pedals of the electric cycle; and (C) Electronic coater with regenerative braking.

FIG. 6 illustrates another mode of operation of the electric cycle according to a number of variations. In the mode of operation illustrated by FIG. 6, the pedal assemblies 16, 18 are locked in a horizontal position to prevent both forward and backward pedaling. The torque (and/or optionally a speed and direction sensor) sensor 62 may be utilized to provide both motor throttle and regenerative braking commands in a manner which is intuitive for the rider. When the rider applies a clockwise force to one of the pedal assemblies 16, 18, the torque is used as a throttle command for the motor/generator 12. When a counterclockwise force is applied to one of the pedal assemblies 16, 18, a regenerative braking command is applied to the motor/generator 12 based upon the torque applied by the rider. Electricity produced by the motor braking operation may be stored in the battery assembly 14. This mode of operation illustrated by FIG. 6 allows for the following state functions: (C) Electronic coater with regenerative braking; (D) Pedal force throttle function wherein the clockwise rotation of the crank is lock and wherein the force applied on a forward pedal by the ride is detected and used as a throttle input to the motor/generator.

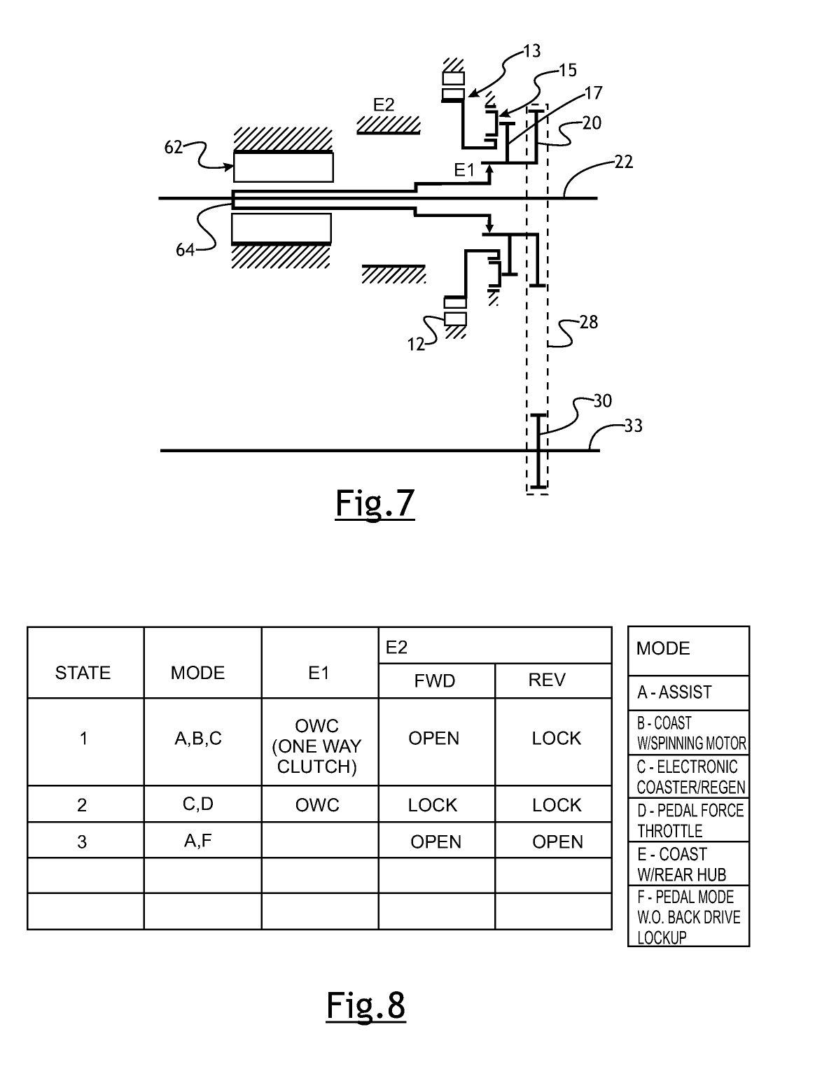

FIG. 7 illustrates another mode of operation of the electric cycle according to a number of variations. In the mode of operation illustrated by FIG. 7, the pedal assemblies 16, 18 rotate the crank 22. Forward and backward pedaling is allowed (freewheeling). This mode of operation illustrated by FIG. 7 allows for the following state functions: (A) Assist function wherein the torque, speed and direction of the crank is detected and assistance in rotating the crank is provided by the electric motor/generator in response to the detected torque, speed and direction of the crank; and (F) Pedal mode without back drive lockup wherein the rider can rotate the crank in a clockwise direction to move the electric cycle forward, and the ride can rotate the crank in a counter clockwise direction in a free spinning mode without back drive lockup.

FIG. 8 is a chart of three different states (States 1-3) for an electric cycle to achieve modes of operations A-F, and identifying the operation conditions for E1 and E2 according to a number of variations.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include an electric cycle having a pedal force-based propulsion system, which allows the rider to provide intuitive input commands using foot pedals, wherein the rider applies a clockwise force to a crank of the electric cycle by applying force to a forward positioned foot pedal of a pedal assembly to move the electric cycle in a forward direction, and the rider applies a counter clockwise force to the crank by applying force to a rearward positioned foot pedal of the pedal assembly to slow the electric cycle.

Variation 2 may include an electric cycle as set forth in Variation 1 further including a means for measuring the torque applied to the crank of the electric cycle to control operations of an electric motor/generator to move the cycle forward or for a regenerative braking.

Variation 3 may include an electric cycle comprising a crank assembly including a mechanical mechanism constructed and arranged to selectively provide at least one of: the free rotation of first and second pedal assemblies of the electric cycle in both the clockwise and counterclockwise directions; locking the first and second pedal assemblies of the electric cycle to prevent rotation in both the clockwise and counterclockwise directions; locking the first and second pedal assemblies of the electric cycle to prevent movement in the clockwise direction but allowing rotation in the counterclockwise direction; or locking the first and second pedal assemblies of the electric cycle to prevent rotation in the counterclockwise direction but allowing rotation in the clockwise direction.

Variation 4 may include an electric cycle as set forth in Variation 3 further including a means for measuring the torque applied to the crank of the electric cycle to control operations of an electric motor/generator to move the cycle forward or for a regenerative braking.

Variation 5 may include an electric bicycle powertrain including a planetary gear set including a sun gear, ring gear and a carrier wherein the motor is connected to the sun gear, the ring gear is connected to a housing, and a drive sprocket is connected to the carrier.

Variation 6 may include an electric cycle comprising a mechanical mechanism constructed and arranged to selectively provide for at least one of the following functions: (A) assist function wherein the at least one of torque, speed or direction of the crank is detected and assistance in rotating the crank is provided by the electric motor/generator in response to the detected torque, speed or direction of the crank; (B) coast with spinning motor/generator function wherein the crank is coupled to the electric motor/generator and the ride is not rotating the pedals of the electric cycle; (C) electric coaster with regenerative braking; (D) pedal force throttle function wherein the clockwise rotation of the crank is locked and wherein the force applied on a forward pedal by the rider is detected and used as a throttle input to the motor/generator; (E) coast with rear hub function; or (F) pedal mode without back drive lockup wherein the rider can rotate the crank in a clockwise direction to move the electric cycle forward, and the ride can rotate the crank in a counter clockwise direction in a free spinning mode without back drive lockup or locking the rear wheel when moving backwards.

Variation 7 may include an electric cycle comprising a motor/generator may be attached to a cycle frame; a crank mechanism comprising a crankshaft having a first pedal assembly and a second pedal assembly connected thereto; the first pedal assembly including a first foot pedal, and the second pedal assembly including a second foot pedal; a mechanical mechanism connected to the crank assembly; a chain ring or sprocket operatively connected to the crank for driving a chain operatively connected to a rear sprocket of a rear wheel; the mechanical mechanism being constructed and arranged to allow at least one of the following: (1) the free rotation of the first and second pedal assemblies in both the clockwise and counterclockwise directions; (2) locking the first and second pedal assemblies and preventing rotation in both the clockwise and counterclockwise directions; (3) locking the first and second pedal assemblies preventing movement in the clockwise direction and allowing rotation in the counterclockwise direction; or (4) locking the first and second pedal assemblies preventing rotation in the counterclockwise direction but allowing rotation in the clockwise direction.

Variation 8 may include an electric cycle as set forth in Variation 7 wherein the mechanical mechanism comprises a base plate having a plurality of tabs pivotally connected thereto, a spring connected to one of the tabs and to the base plate to bias the same in one direction, a cap for lying over the base plate, the cap being operatively connected to the crank, the cap having a plurality of recesses formed therein defined by features in the cap so that each of the plurality of recesses is defined in part by a shoulder against which one of the tabs locks and prevents rotation of the cap in at least one direction, the cap operatively tied to the crank to allow or prevent rotation of the same.

Variation 9 may include an electric cycle as set forth in any of Variations 7-8 wherein the mechanical mechanism is servo controlled or manually controlled causing the tabs to move into or out of locking position with respect to the shoulder of the recesses formed in the cap.

Variation 10 may include an electric cycle as set forth in any of Variations 7-9 further comprising a one way clutch connected to ground and to the crank, a second clutch connected to the chain ring or sprocket, the second clutch arranged to provide the functions: (A) assist function wherein at least one of the torque, speed or direction of the crank is detected and assistance in rotating the crank is provided by the electric motor/generator in response to the detected torque, speed or direction of the crank; (B) coast with spinning motor/generator function wherein the crank is coupled to the electric motor/generator and the ride is not rotating the pedals of the electric cycle; and (C) electric coaster with regenerative braking.

Variation 11 may include an electric cycle as set forth in any of Variations 7-10 further comprising a one way clutch connected to ground and to the crank, a second clutch connected to the chain ring or sprocket, the second clutch arranged to provide the functions; C) electric coaster with regenerative braking; and (D) pedal force throttle function wherein the clockwise rotation of the crank is locked and wherein the force applied on a forward pedal by the rider is detected and used as a throttle input to the motor/generator.

Variation 12 may include an electric cycle as set forth in any of Variations 7-11 further comprising a second clutch connected to the chain ring or sprocket, the second clutch arranged to provide the functions: (A) assist function wherein at least one of the torque, speed or direction of the crank is detected and assistance in rotating the crank is provided by the electric motor/generator in response to the detected torque, speed or direction of the crank; and (F) pedal mode without back drive lockup wherein the rider can rotate the crank in a clockwise direction to move the electric cycle forward, and the ride can rotate the crank in a counter clockwise direction in a free spinning mode without back drive lockup or locking the rear wheel when moving backwards.

The above description of select variations within the scope of the invention is merely illustrative in nature and, thus, variations or variants thereof are not to be regarded as a departure from the spirit and scope of the invention.

What is claimed is:

1. An electric cycle having a pedal force-based propulsion system comprising a pedal assembly comprising first and second foot pedals, a crank connected to the first and second foot pedals, an electric motor/generator, and electronic controls operatively connected to the electric motor/generator and to a means for a rider to provide input commands using the foot pedals, wherein the rider applies a clockwise force to the crank of the electric cycle by applying force to a forward positioned foot pedal of the pedal assembly to move the electric cycle in a forward direction using the electric motor/generator, and the rider applies a counter clockwise force to the crank by applying force to a rearward positioned foot pedal of the pedal assembly to slow the electric cycle using the electric motor/generator.

2. An electric cycle as set forth in claim 1 further including a means for measuring the torque applied to the crank of the electric cycle to control operations of an electric motor/generator to move the cycle forward or for a regenerative braking.

3. An electric cycle comprising a crank assembly including a mechanical mechanism constructed and arranged to selectively provide at least one of: the free rotation of first and second pedal assemblies of the electric cycle in both the clockwise and counterclockwise directions; locking the first and second pedal assemblies of the electric cycle to prevent rotation in both the clockwise and counterclockwise directions; locking the first and second pedal assemblies of the electric cycle to prevent movement in the clockwise direction but allowing rotation in the counterclockwise direction; or locking the first and second pedal assemblies of the electric cycle to prevent rotation in the counterclockwise direction but allowing rotation in the clockwise direction.

4. An electric cycle as set forth in claim 3 further including a means for measuring the torque applied to the crank of the electric cycle to control operations of an electric motor/generator to move the cycle forward or for a regenerative braking.

5. An electric bicycle powertrain including a planetary gear set including a sun gear, ring gear and carrier, and a motor connected to the sun gear, and wherein the ring gear is connected to a housing, and a drive sprocket is connected to the carrier.

6. An electric cycle comprising a mechanical mechanism constructed and arranged to selectively provide for at least one of the following functions: (A) assist function wherein at least one of the torque, speed or direction of the crank is detected and assistance in rotating the crank is provided by the electric motor/generator in response to the detected torque, speed or direction of the crank; (B) coast with spinning motor/generator function wherein the crank is coupled to the electric motor/generator and the ride is not rotating the pedals of the electric cycle; (C) electric coaster with regenerative braking; (D) pedal force throttle function wherein the clockwise rotation of the crank is locked and wherein the force applied on a forward pedal by the rider is detected and used as a throttle input to the motor/generator; (E) coast with rear hub function; or (F) pedal mode without back drive lockup wherein the rider can rotate the crank in a clockwise direction to move the electric cycle forward, and the ride can rotate the crank in a counter clockwise direction in a free spinning mode without back drive lockup or locking the rear wheel when moving backwards.

7. An electric cycle comprising a motor/generator attached to a cycle frame; a crank mechanism comprising a crankshaft having a first pedal assembly and a second pedal assembly connected thereto; the first pedal assembly including a first foot pedal, and the second pedal assembly including a second foot pedal; a mechanical mechanism connected to the crank assembly; a chain ring or front sprocket operatively connected to the crank for driving a chain operatively connected to a rear sprocket of a rear wheel; the mechanical mechanism being constructed and arranged to allow at least one of the following: (1) the free rotation of the first and second pedal assemblies in both the clockwise and counterclockwise directions; (2) locking the first pedal assembly and second pedal assembly and preventing rotation in both the clockwise and counterclockwise directions; (3) locking the first pedal assembly and second pedal assembly preventing movement in the clockwise direction and allowing rotation in the counterclockwise direction; or (4) locking the first pedal assembly and second pedal assembly preventing rotation in the counterclockwise direction but allowing rotation in the clockwise direction.

8. An electric cycle as set forth in claim 7 wherein the mechanical mechanism comprises a base plate having a plurality of tabs pivotally connected thereto, a spring connected to one of the tabs and to the base plate to bias the same in one direction, a cap for lying over the base plate, the cap being operatively connected to the crank, the cap having a plurality of recesses formed therein defined by features in the cap so that each of the plurality of recesses is defined in part by a shoulder against which one of the tabs locks and prevents rotation of the cap in at least one direction, the cap operatively tied to the crank to allow or prevent rotation of the same.

9. An electric cycle as set forth in claim 8 wherein the mechanical mechanism is servo controlled or manually controlled causing the tabs to move into or out of locking position with respect to the shoulder of the recesses formed in the cap.

10. An electric cycle as set forth in claim 8 further comprising a one way clutch connected to ground and to the crank, a second clutch connected to the chain ring or front sprocket, the second clutch arranged to provide the functions: (A) assist function wherein at least one of the torque, speed or direction of the crank is detected and assistance in rotating the crank is provided by the electric motor/generator in response to the detected torque, speed or direction of the crank; (B) coast with spinning motor/generator function wherein the crank is coupled to the electric motor/generator and the ride is not rotating the pedals of the electric cycle; and (C) electric coaster with regenerative braking.

11. An electric cycle as set forth in claim 8 further comprising a one way clutch connected to ground and to the crank, a second clutch connected to the chain ring or front sprocket, the second clutch arranged to provide the functions; C) electric coaster with regenerative braking; and (D) pedal force throttle function wherein the clockwise rotation of the crank is locked and wherein the force applied on a forward pedal by the rider is detected and used as a throttle input to the motor/generator.

12. An electric cycle as set forth in claim 8 further comprising a second clutch connected to the chain ring or front sprocket, the second clutch arranged to provide the functions: (A) assist function wherein at least one of the torque, speed or direction of the crank is detected and assistance in rotating the crank is provided by the electric motor/generator in response to the detected torque, speed or direction of the crank; and (F) pedal mode without back drive lockup wherein the rider can rotate the crank in a clockwise direction to move the electric cycle forward, and the ride can rotate the crank in a counter clockwise direction in a free spinning mode without back drive lockup or locking the rear wheel when moving backwards.
